(19) United States
(12) Patent Application Publication
(10) Pub. No.: US 2010/0189990 A1
(43) Pub. Date: Jul. 29, 2010

(54) HIGH THERMAL CONDUCTIVITY ELECTRODE SUBSTRATE

(76) Inventor: Richard D. Breault, North Kingstown, RI (US)

Correspondence Address: CARLSON, GASKEY & OLDS, P.C., 400 WEST MAPLE ROAD, SUITE 350, BIRMINGHAM, MI, 48009, US

(21) Appl. No.: 12/671,071

(22) PCT Filed: Sep. 19, 2007
(86) PCT No.: PCT/US07/78821

§ 371 Date: Jan. 28, 2010

(51) Int. Cl. H01M 4/58; B32B 5/16; B32B 5/18; B32B 5/02; H01M 4/36; B05D 3/00

(52) U.S. Cl. 428/311.51; 428/323; 427/121

(57) ABSTRACT

An electrode substrate is disclosed that includes a plane and a through-plane direction. First and second carbon fibers are respectively arranged in the plane and through-plane direction. The substrate includes a thickness in the through-plane direction and the second fiber has a length less than the thickness. The first carbon fiber has a length greater than the thickness. In one example method of manufacturing the example substrate, PAN-based carbon fibers are blended with meso-phase pitch-based carbon fibers. A resin is applied to a non-woven felt constructed from the carbon fibers. The felt and resin are heated to a desired temperature to achieve a desired through-plane thermal conductivity.

### BACKGROUND

This disclosure relates to a carbon-carbon composite suitable for use as a substrate in fuel cells, for example.

Some types of fuel cells, such as proton exchange membrane and phosphoric acid fuel cells (PEMFC and PAFC), use porous carbon-carbon composites as electrode substrates, which are also referred to as gas diffusion layers. One example fuel cell substrate and manufacturing process is shown in U.S. Pat. No. 4,851,304.

One typical method of making a substrate includes: (1) forming a non-woven felt from a chopped carbon fiber and a temporary binder by a wet-lay paper making process, (2) impregnating or pre-pregging the felt with a phenolic resin dissolved in a solvent followed by solvent removal without curing the resin, (3) pressing one or more layers of felt to a controlled thickness and porosity at a temperature sufficient to cure the resin, (4) heat treating the felt in an inert atmosphere to between 750-1000° C. to convert the phenolic resin to carbon, and (5) heat treating the felt in an inert atmosphere to between 2000-3000° C. to improve thermal and electrical conductivities and to improve corrosion resistance.

Thermal conductivity is important because it impacts acid life in a PAFC and hot cell temperature, which effects fuel cell durability, for example. Achieving desired through-plane thermal conductivity can be especially difficult. The through-plane thermal conductivity of some substrates is less than desired, for example, approximately 2 W/m-K. One cause of low through-plane thermal conductivity is that the carbon fibers are generally aligned in the planar direction of the substrate as opposed to being aligned more in the through-plane direction. The thermal conductivity of carbon fibers arranged in the through-plane direction is significantly lower when they are arranged in the planar direction as compared to the through-plane direction. Typically, PAFC substrates are about 0.40 mm thick and are made from polyacrylonitride (PAN) based carbon fibers that are 6-12 mm long, which provides an aspect ratio of the fiber length to the thickness of the substrate of 15-30:1. Thus, the PAN fibers cannot be arranged in the through-plane direction. A substrate with higher through-plane thermal conductivity is desired, in particular, a conductivity of approximately 4 W/m-K or greater.

### SUMMARY

An electrode substrate is disclosed that includes a plane and a through-plane direction. First and second carbon fibers are respectively arranged in the plane and through-plane direction. The substrate includes a thickness in the through-plane direction and the second fibers have a length less than the thickness. The first carbon fiber has a length greater than the thickness, in the example. The first fibers, which are long, provide strength and porosity to the substrate. The second fibers, which are short, improve through-plane thermal conductivity as well as electrical conductivity.

In one example method of manufacturing the example substrate, PAN-based carbon fibers are blended with meso-phase pitch-based carbon fibers. A resin is applied to a non-woven felt constructed from the PAN-based and meso-phase pitch-based carbon fibers. The felt and resin are heated to a desired temperature to achieve a desired thermal conductivity.

Accordingly, the disclosed embodiment provides a substrate with an increased through-plane thermal conductivity over prior art carbon based electrode substrates.

These and other features of the present invention can be best understood from the following specification and drawings, the following of which is a brief description.

### BRIEF DESCRIPTION OF THE DRAWINGS

FIG. 1 is a highly schematic view of one example fuel cell.

FIG. 2 is a highly schematic view of an enlarged partial cross-sectional view of an electrode substrate.

FIG. 3 illustrates an estimate of through-plane thermal conductivity of the example electrode substrate.

### DETAILED DESCRIPTION OF THE PREFERRED EMBODIMENT

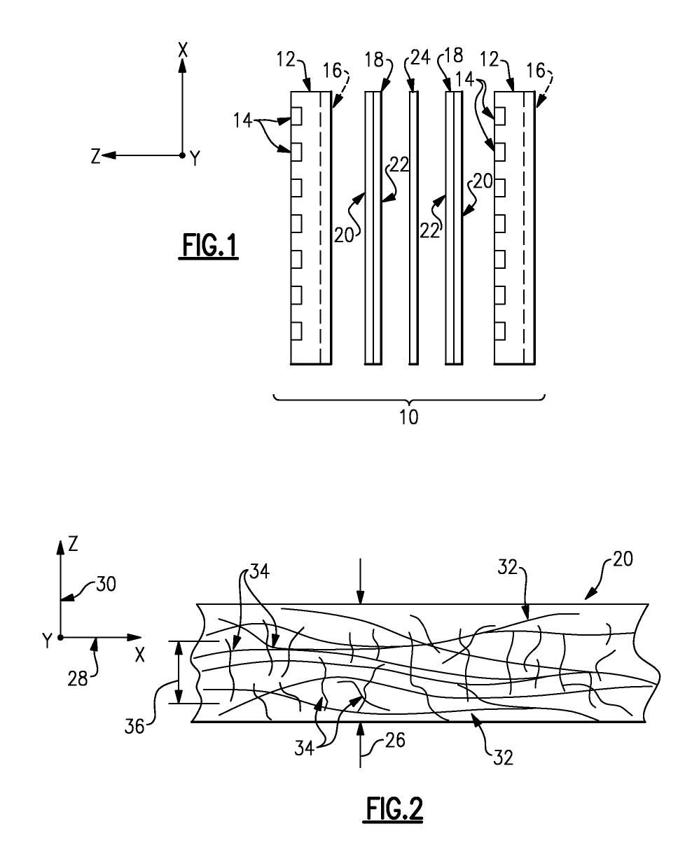

An example fuel cell 10 is schematically shown in FIG. 1. Multiple cells 10 are arranged adjacent to one another in the Z-direction to form a stack (Z direction not shown in FIG. 1). The fuel cell 10 includes gas separators 12 having fuel passages 14 arranged on one side and oxidant passages 16 arranged on the opposing side. For one type of example gas separator 12, the fuel and oxidant passages 14, 16 are arranged perpendicularly relative to one another for respectively carrying a hydrogen rich fuel and air. Electrodes 18 are arranged on either side of an electrolyte layer 24 and adjacent to the gas separators 12. The components of the fuel cell 10 operate in a known manner. The electrodes 18 include a substrate 20 and a catalyst 22, in one example embodiment.

Typically, the substrate 20 is constructed from carbon fibers. The type and size of carbon fibers are selected to provide various desired parameters of the substrate 20. The example substrate 20 is a porous carbon-carbon composite, which may be used as an electrode substrate in a fuel cell to provide through-plane (Z-direction) thermal conductivity 2-3 times greater than presently available materials. A blend of long and short carbon fibers is used, which is provided by PAN and meso-phase pitch-based fibers, in one example. Meso-phase pitch based fibers are much more graphitizable than PAN based carbon fibers. Thermal conductivity of meso-phase pitch based fibers in the longitudinal direction of the fiber increases as the heat treat temperature of the fiber is increased. The conductivity of graphitized meso-phase pitch is as high as 1,000 W/m-K in the longitudinal direction.

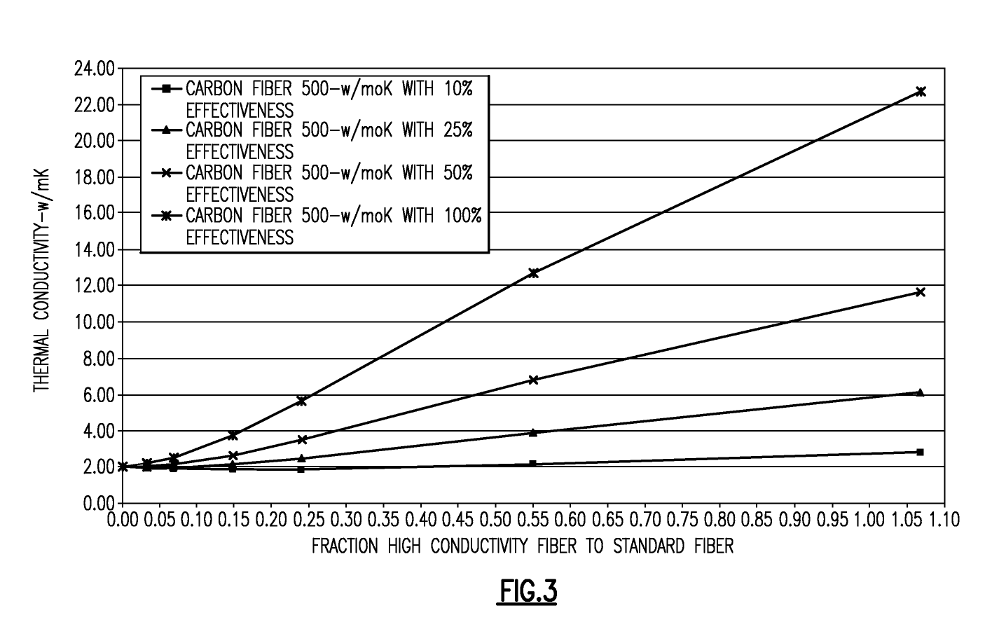

An enlarged cross-sectional view of a portion of the substrate 20 is shown in FIG. 2. The substrate 20 is constructed from at least a first and second carbon fiber that are different than one another. The substrate 20 extends in a plane 28 arranged in X- and Y-directions. The substrate 20 has a thickness 26 along a Z-direction. The thickness 26 is oriented the through-plane direction. First fibers 32 correspond to PAN-based carbon fibers, in one example. Second fibers 34 correspond to meso-phase pitch-based carbon fibers, in one example. The length of the first fibers 32 is significantly longer than the thickness 26. The length 36 of the second fibers 34 are shorter than the thickness 26 so they can extend generally perpendicular to the plane 28 and in the through-plane direction 30.

The majority of the fibers are first fibers 32 (long PAN based fibers) with a fiber length to substrate thickness aspect ratio of 15-30:1. These long fibers are orientated in the plane 28 and result in a high porosity and high flex strength.

The minority of the fibers are second fibers 34 (short meso-phase pitch-based fibers) with a fiber length to substrate thickness aspect ratio of 0.25-0.50:1. The short fibers are oriented in the through-plane direction for improved through-plane thermal conductivity.

PAN based carbon fibers are disclosed in the example for the long fibers relative to either an isotropic pitch based carbon fiber or a meso-phase pitch based carbon fiber. However, isotropic or meso-phase pitch based fibers may be used in place of the PAN based fibers. The long fibers are generally referred to as “chopped” fibers, which have a length greater than 1 mm and typically 3-12 mm. The short fibers may be carbonized pitch based carbon fibers heat treated at a temperature between 1000-3000° C. The short fibers are generally referred to as “milled” fibers with a length of less than 0.50 mm and typically 0.10-0.20 mm. In one example, the meso-phase pitch based carbon fibers are graphitized at a temperature of 2000-3000° C. Alternatively, the meso-phase pitch based carbon fiber may be a carbonized fiber that is subsequentially converted to graphite as part of the substrate heat treat process.

The density of the preferred substrates is between 0.38 to 0.76 gm/ml with a typical value being about 0.58 gm/ml. These densities correspond to a porosity range of 60 to 80 percent with the typical value being about 70 percent.

In one example, a mathematical model is used to estimate the through-plane thermal conductivity of a porous substrate as a function of composition. The model is comprised of two-parallel paths, one in the PAN-based fiber and the other in the pitch-based fiber. The over-all bulk density of the substrate was held constant at 0.58 gm/ml, in one example, which is equal to a porosity of 70%. Variables considered were the conductivity of the pitch-based carbon fiber, the ratio of pitch based carbon fiber to PAN-based carbon fiber and the effectiveness of the orientation of the pitch based fiber. The thermal conductivity of the porous composite, k, is given by:

k=kₒθb+εk_{pitch}θ_{pitch}b

k=conductivity porous composite

kₒ=conductivity solid PAN based composite

k_{pitch}=conductivity pitch fiber

Θ=void fraction PAN solids

Θ_{pitch}=void fraction pitch solids

b=1.7 for both phases

ε=effectiveness of orientation

The thermal conductivity, k, can be expressed as a function of composition and effectiveness of the fiber orientation. FIG. 3 is an estimate of the through-plane thermal conductivity of a substrate, with a density of 0.58 gm/ml, as a function of the fraction of high conductivity fiber to standard fiber, and as a function of the effectiveness of the orientation of the high conductivity fiber. A pitch to PAN ratio of 0.4 (29% pitch) is predicted to have a thermal conductivity of approximately 5 W/m-K if the effectiveness of the fiber orientation is 50%. This represents a 2.5 fold increase over the baseline material.

Suitable meso-phase pitch based carbon fibers are available from Cytec, for example. Cytec ThermalGraph DKD is a high conductivity fiber with an axial conduction of 400-700 W/m-K. The standard fiber is available as a milled fiber with an average length of 0.20 mm. A 0.10 mm fiber can also be obtained. These fibers result in a fiber to substrate aspect ratio of 0.25-0.50:1 for a substrate thickness of 0.40 mm.

### First Example Substrate Manufacturing Method

An illustrative method of making a substrate consists of: (1) creating an aqueous suspension, consisting of chopped PAN based carbon fibers and milled meso-phase pitch based carbon fibers, a temporary binder such as polyvinyl alcohol, (2) forming a non-woven felt from the suspension by a wet-lay paper making process, (3) dewatering the felt by a combination of removing the water by gravity and vacuum on the wire screen and drying the felt by heating the felt, (4) impregnating or pre-pregging the felt with a phenolic resin dissolved in a solvent followed by solvent removal without curing the resin, (5) pressing one or more layers of felt to a controlled thickness and porosity at a temperature (175+/−25° C.) sufficient to first melt and then cure and cross-link the resin for a time of 1-5 minutes, (6) heat treating the felt in an inert atmosphere to between 750-1000° C. to convert the phenolic resin to carbon, and (7) heat treating the felt in an inert atmosphere to between 2000-3000° C. to partially graphitize the materials and preferably heat treated between 2500-3000° C. to maximize the thermal conductivity.

### Second Example Substrate Manufacturing Method

The example substrate can also be used in a dry-lay non-woven forming process by: (1) creating a dry blend consisting of chopped PAN based carbon fibers and milled pitch based carbon fibers, chopped novolac fibers or a powdered phenolic resin, a temporary binder such as polyvinyl alcohol powder and a curing agent such as powdered hexa, (2) forming a non-woven felt from a fluidized stream of the dry powder blend by a dry-lay non-woven forming process, (3) heating the felt at a sufficiently low felt temperature (100+/−25° C.) that the resin does not cross-link to provide sufficient strength for handling, (4) pressing one or more layers of felt to a controlled thickness and porosity at a temperature (175+/−25° C.) sufficient to first melt and then cure and cross-link the resin for a time of 1-5 minutes, (5) heat treating the felt in an inert atmosphere to between 750-1000° C. to convert the phenolic resin to carbon and (6) heat treating the felt in an inert atmosphere to between 2000-3000° C. and preferably heat treated between 2500-3000° C. to maximize the thermal conductivity.

The resulting carbon composite provides a thermal conductivity 2-3 times greater than presently available materials for use in electrochemical cells that consists of a precursor felt that contains a blend of long and short fibers (a blend of PAN and meso-phase pitch based fibers). The majority of the fibers are long PAN based fibers with a fiber to substrate thickness aspect ratio of 15-30:1. The minority of the fibers are short meso-phase pitch based fibers with a fiber to substrate thickness aspect ratio of 0.25-0.50:1. The ratio of meso-phase pitch based carbon fibers to PAN based carbon fibers is between 0.3-1.0.

The thermal conductivity of the substrate is doubled in the example embodiment, reducing the hot cell temperature by about 7° C. at 8 cells per cooler, which results in improved performance durability and reduced acid loss. Alternatively, doubling the thermal conductivity permits the cells per cooler to be increased from 8 to about 11-12 while maintaining the same hot cell temperature thus resulting in reduced cost.

This discussion has focused on improving thermal conductivity. One skilled in the art will recognize that carbon fiber orientations and carbon fiber compositions that improve through-plane thermal conductivity will also improve through-plane electrical conductivity. This is beneficial because it will lower the resistance of the fuel cell substrate resulting in higher cell voltages.

Although an example embodiment has been disclosed, a worker of ordinary skill in this art would recognize that certain modifications would come within the scope of the claims. For that reason, the following claims should be studied to determine their true scope and content.

1. An electrode substrate comprising a plane and a through-plane direction, first and second carbon fibers respectively arranged in the plane and through-plane directions, the substrate having a thickness in the through-plane direction and the second fiber having a length less than the thickness, and the first carbon fiber having a length greater than the thickness.

2. The electrode substrate according to claim 1, wherein the first fibers are PAN-based carbon fibers and the second fibers are meso-phase pitch fibers.

3. The electrode substrate according to claim 2, wherein the second fibers include a length to thickness aspect ratio of approximately 0.25-0.50:1.

4. The electrode substrate according to claim 2, wherein the length is approximately less than 0.5 mm.

5. The electrode substrate according to claim 4, wherein the length is substantially less than approximately 0.4 mm.

6. The electrode substrate according to claim 5, wherein the length is an average length of approximately 0.1-0.2 mm.

7. The electrode substrate according to claim 1, wherein the first fibers include a fiber length to thickness aspect ratio of approximately 15-30:1.

8. The electrode substrate according to claim 7, wherein the first fibers include a length of approximately greater than 1 mm.

9. The electrode substrate according to claim 8, wherein the fiber length is between approximately 3-12 mm.

10. The electrode substrate according to claim 9, wherein the fiber length is between approximately 6-12 mm.

11. The electrode substrate according to claim 1, wherein the electrode substrate includes an over-all bulk density of approximately 0.38 to 0.76 gm/ml.

12. The electrode substrate according to claim 11, wherein the electrode substrate includes a porosity of approximately 60 to 80%.

13. The electrode substrate according to claim 1, wherein the electrode substrate comprises a thermal conductivity in the through-plane direction of approximately 4 to 8 W/m-K.

14. The electrode substrate according to claim 1, wherein the ratio of second fibers to first fibers is approximately between 0.3-1.0.

15. The electrode substrate according to claim 1, wherein the thermal conductivity in the through-plane direction is greater than or equal to approximately 4 w/m-k.

16. A method of manufacturing an electrode substrate comprising the steps of:
blending chopped carbon fibers with milled carbon fibers;
applying a resin to a non-woven felt constructed from the chopped and milled carbon fibers;
pressing and curing one or more plys of felt; and
heating the felt and resin to a desired temperature in an inert atmosphere to achieve a desired thermal conductivity.

17. The method according to claim 16, wherein the desired thermal conductivity corresponds to a through-plane conductivity of greater than or equal to approximately 4 W/m-K.

18. The method according to claim 17, wherein felt includes a thickness and the milled fibers include a fiber length to thickness aspect ratio of approximately between 0.25-0.50:1.
